(19) United States
(12) Patent Application Publication
(10) Pub. No.: US 2015/0142955 A1
(43) Pub. Date: May 21, 2015

(54) METHODS AND SYSTEMS FOR FACILITATING NETWORK SWITCHING

(71) Applicant: WEFI INC., Marlborough, MA (US)

(72) Inventors: Shimon Scherzer, Korazim (IL); Eran Naveh, Tel Aviv (IL); David Fishman, Denver, CO (US)

(73) Assignee: WEFI INC., Marlborough, MA (US)

(21) Appl. No.: 14/154,470

(22) Filed: Jan. 14, 2014

Related U.S. Application Data
(60) Provisional application No. 61/906,436, filed on Nov. 20, 2013.

(51) Int. Cl. H04L 12/26

(52) U.S. Cl. CPC H04L 43/0876
USPC 709/224

(57) ABSTRACT

Methods, servers, and mobile devices for network selection are disclosed. A server may receive a first set of data reflecting network performance status of a first network at a plurality of locations and network performance status of a second network at the plurality of locations. The server may also receive, for example from a mobile device, a second set of data reflecting network device usage for a device operating in association with the plurality of locations. The server may also output data associated with a proposed network for the device based, at least in part, on a determination of a first impact of the network device usage on the network performance status of the first network and a determination of a second impact of the network device usage on the network performance status of the second network.

### RELATED APPLICATIONS

The present application claims the benefit of U.S. Provisional Application No. 61/906,436, filed Nov. 20, 2013, the entirety of which is incorporated herein by reference.

### TECHNICAL FIELD

The present disclosure relates to the field of network usage analysis and, more particularly, methods, servers, and mobile devices for network selection.

### BACKGROUND

Multiple wireless communications service providers (CSPs) often serve common geographical regions. Therefore, a mobile device user often can choose to use a variety of CSPs that meet his or her needs.

A network employed by a CSP typically includes a variety of access points including, for example, cellular base stations, small cell access points, and wireless local area network (WLAN) access points. But, while different CSPs may enable a mobile device to access a wireless network, the user experience on each network (e.g., network speed) and the resources available on a network (e.g., the network volume and bandwidth in a particular geographical region) may vary.

Typically, a user has, at best, only a small amount of information to use when selecting among CSPs serving a geographical region. Moreover, CSPs usually have no information about a user's usage pattern before making a proposal to the user for using a network.

Improvements in techniques for selecting a CSP to use for a user's mobile device, including techniques for switching from one network of a first CSP to a second network of a second CSP, are desirable.

### SUMMARY

In one disclosed embodiment, a network selection method is disclosed. The method comprises receiving a first set of data reflecting network performance status of a first network at a plurality of locations and network performance status of a second network at the same locations. The method also comprises receiving a second set of data reflecting network device usage for a device operating in association with the same locations. In addition, the method comprises outputting data associated with a proposed network for the device based, at least in part, on a determination of a first impact of the network device usage on the network performance status of the first network and a determination of a second impact of the network device usage on the network performance status of the second network.

In another disclosed embodiment, a network selection method is disclosed. The method comprises outputting a set of data reflecting network device usage for a device operating in association with a plurality of locations. The method also comprises receiving data associated with a proposed network for the device based, at least in part, on a determination of a first impact of the network device usage on network performance status of a first network and a determination of a second impact of the network device usage on network performance status of a second network.

In another disclosed embodiment, a server is disclosed. The server comprises at least one processor and at least one memory device. The server is configured to receive a first set of data reflecting network performance status of a first network at a plurality of locations and network performance status of a second network at the plurality of locations, receive a second set of data reflecting network device usage for a device operating in association with the plurality of locations, and output data associated with a proposed network for the device based, at least in part, on a determination of a first impact of the network device usage on the network performance status of the first network and a determination of a second impact of the network device usage on the network performance status of the second network.

In another disclosed embodiment, a mobile device is disclosed. The mobile device comprises at least one processor and at least one memory. The memory stores instructions that, when executed by the at least one processor, output a set of data reflecting network device usage for a device operating in association with a plurality of locations and receive data associated with a proposed network for the device based, at least in part, on a determination of a first impact of the network device usage on network performance status of a first network and a determination of a second impact of the network device usage on network performance status of a second network.

Additional aspects related to the embodiments will be set forth in part in the description which follows, and in part will be obvious from the description, or may be learned by practice of the invention.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several exemplary embodiments.

FIG. 1 illustrates an example geographical region in accordance with some of the disclosed embodiments.

FIG. 2 illustrates an example system that may be used for implementing the disclosed embodiments.

FIG. 3 illustrates an example network selection method for implementing the disclosed embodiments.

FIG. 4 illustrates an example network selection method for implementing the disclosed embodiments.

FIG. 5 illustrates an example traffic intensity map in accordance with some of the disclosed embodiments.

FIG. 6 illustrates an example network usage map in accordance with some of the disclosed embodiments.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

This application discloses methods and systems for proposing to change or changing a wireless device's network being used from a first network facilitating wireless communications among a plurality of locations and/or times to a second network facilitating wireless communications among the same locations and/or times. In some embodiments, a server receives a first set of data representing network performance status of a first network at a plurality of locations and/or times and network performance status of a second network at the same locations and/or times. As described in more detail below, network performance status may include various aspects of a network's ability to provide users with wireless network access.

In some embodiments, the server also receives a second set of data reflecting network usage by a user. As described in more detail below, network usage may include various aspects of a user's consumption of wireless network resources.

In some embodiments, the server outputs data associated with a change of network being used based, at least in part, on a determination of a first impact of the network device usage on the network performance status of the first network and a determination of a second impact of the network device usage on the network performance status of the second network. For example, the server may cause, or propose, a user device to switch from using a first network to using a second network if it is determined that the network device usage of the user device would have a minimal impact on the second network or a smaller impact on the second network than the first network. Moreover, or alternatively, the server may cause, or propose, a user device to switch between networks following a proper command. For example, a device that may roam on multiple networks where the decision on which network to stay can be based on the process described herein.

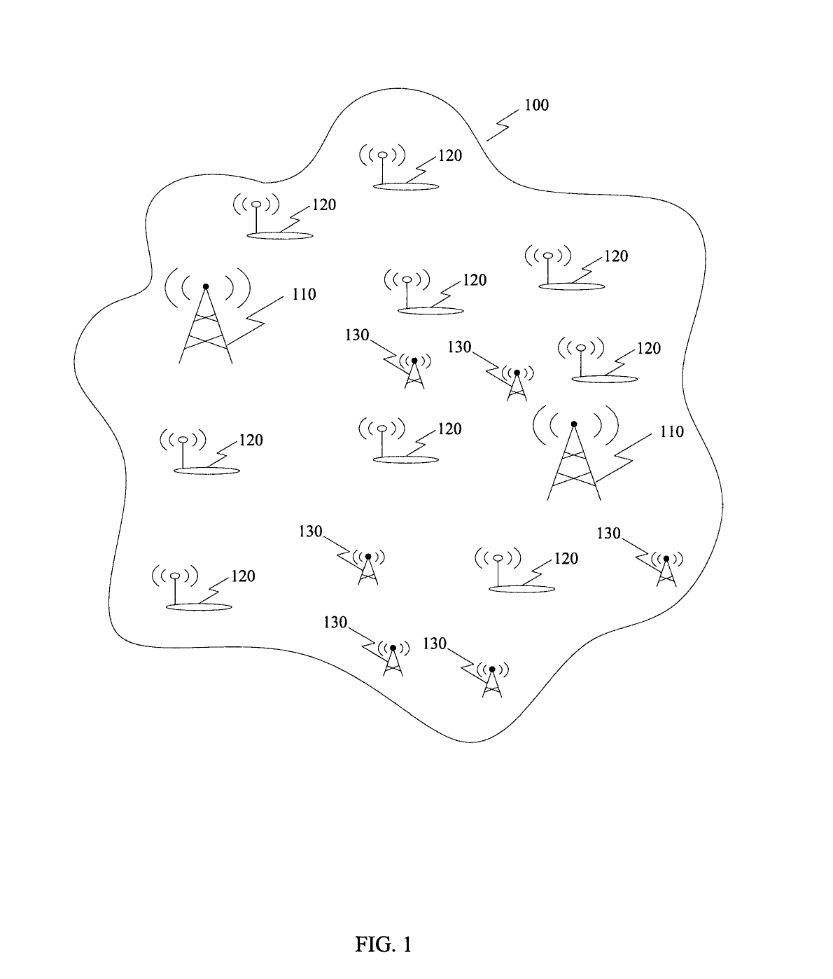

FIG. 1 is a diagram illustrating an example geographic region 100 according to some disclosed embodiments. Geographic region 100 may be, for example, an area within a city, state, or country, or any other geographical area. In some embodiments, geographical region 100 comprises a number of transceivers 110 configured to manage communications in a cellular network protocol, a number of transceivers 120 configured to manage communications in a WLAN network protocol, and a number of other transceivers, such as, for example, transceivers 130 configured to manage communications in a small cell network. In some embodiments, the area serviced (i.e., the area provided wireless network coverage) by one or more cellular networks' transceivers 110, one or more WLAN networks' transceivers 120, and/or one or more other transceivers, can overlap. For example, a cellular transceiver 110 may provide cellular network coverage for a first area and a WLAN transceiver 120 may provide WLAN network coverage for a second area that at least partially overlaps the first area.

Each of the one or more cellular transceivers 110 may be operated by the same CSP or different CSPs. Similarly, each of the WLAN transceivers 120 may be operated by the same CSP or different CSPs. And each of the small cell network transceivers 130 may be operated by the same CSP or different CSPs. Thus, for example, a first small cell network transceiver 130 operated by a first CSP and a second small cell network transceiver 130 operated by a second CSP may provide network coverage for areas that at least partially overlap. While FIG. 1 depicts a specific number of cellular transceivers 110, WLAN transceivers 120, and small cell network transceivers 130, in some embodiments geographical region 100 includes any number of cellular transceivers 110, WLAN transceivers 120, and small cell network transceivers 130, including no cellular transceivers 110, WLAN transceivers 120, or small cell network transceivers 130.

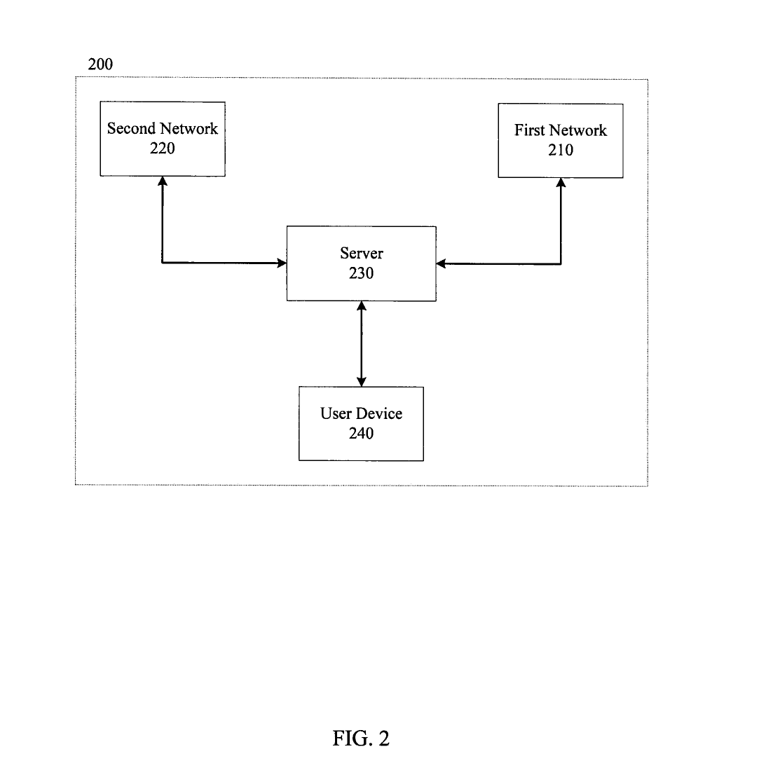

FIG. 2 is a diagram illustrating an example system 200 that may be used to implement some of the disclosed embodiments. In some embodiments, system 200 includes a first network 210, a second network 220, a server 230, and a user device 240. The first network 210 may include, for example, a set of access points including, for example, cellular transceivers 110, a set of WLAN access points including WLAN transceivers 120, and/or a set of small cell access points including small cell network transceivers 130. A set of devices may subscribe to the first network 210. A network “subscription,” as used in this application, includes, for example, a configuration of a user device and/or a configuration of a network that enables the user device to connect to and utilize the access points of the network. A network subscription may also include an agreement or contract to pay money (e.g., on a monthly basis) in exchange for the ability to connect to and/or utilize the access points of the network. A network subscription may also include an agreement to provide a certain level of performance to a user's device. The first network 210 may be controlled, for example, by a first CSP. Control of an access point in a network may include direct control such as, for example, ownership of a cellular transceiver 110 or small cell network transceivers 130, or indirect control such as, for example, an agreement, contract, or other arrangement entered into with an owner or controller of a WLAN transceiver 120. As depicted in FIG. 1, the set of cellular access points, WLAN access points, and/or small cell access points of the first network 210 may be dispersed throughout a geographic region 100.

The second network 220 may also include, for example, a set of cellular access points including cellular transceivers 110, a set of WLAN access points including WLAN transceivers 120, and/or a set of small cell access points including small cell network transceivers 130, configured in the same or substantially same manner as described above with respect to the first network 210. A set of devices may subscribe to the second network 220. The second network 220 may be controlled, for example, by a second CSP. As depicted in FIG. 1, the set of cellular access points, WLAN access points, and/or small cell access points of the second network 220 may be dispersed throughout a geographic region 100.

As described in greater detail below, the first network 210 and the second network 220 may provide data representing network performance status of the first network 210 at a plurality of locations and/or times within geographic region 100 and network performance status of the second network 220 at the plurality of locations and/or times within geographic region 100 to the server 230.

While a first network 210 and a second network 220 are depicted in FIG. 2, in some embodiments more than two networks may provide wireless network service within geographic region 100 and provide data to server 230. For example, a third network of a third CSP may also have access points providing wireless network service within geographic region 100. Thus, for example, the third CSP, or any number of additional networks, may provide wireless network service within geographic region 100 and data to server 230. The data provided to server 230 that is representative of network performance status of the first network 210 and network performance status of the second network 220 may include, for example, (1) data provided by a data processing apparatus of the first network 210, which may receive data from access points of the first network 210 or subscriber devices of the first network 210, (2) data provided by a data processing apparatus of the second network 220, which may receive data from access points of the second network 220 or subscriber devices of the second network 220, (3) data provided by access points of the first network 210, (4) data provided by access points of the second network 220, (5) data provided by subscriber devices of the first network 210, (6) data provided by subscriber devices of the second network 220, or (7) data provided by some other apparatus that is representative of network performance status of the first network 210 or the network performance status of the second network 220.

Data processing apparatuses of the first network 210, data processing apparatuses of the second network 220, server 230, and user device 240 may represent data processing apparatuses that include, among other things, one or more of the following components: a central processing unit (CPU) configured to execute computer program code to perform various processes and methods, including the embodiments herein described; memory, such as RAM, EEPROM, and flash memory, to store data and computer program code; and an input/output device configured to enable data communication with other components.

In some embodiments, user device 240 comprises hardware and/or computer program code for connecting to cellular transceivers 110, WLAN transceivers 120, and/or other networks, such as small cell network transceivers 130. In some embodiments, user device 240 is using the first network 210 or the second network 220. In other embodiments, user device 240 is not using any network, or is using a third network.

In some embodiments, user device 240 is configured transmit data including a representation of network usage at a plurality of locations and/or times within geographic area 100 to server 230. For example, the location of user device 240 may be determined using a GPS device within user device 240 or using a triangulation method. User device 240 may temporarily or permanently record data regarding its network usage at various locations and/or times. User device 240 may transmit the network device usage data associated with the various locations to the server 230 at predetermined times or on-command. In some embodiments, server 230 may also, or alternatively, receive a representation of network usage of a user at a plurality of locations and/or times based on an estimation. For example, in some embodiments, the user device 240 only stores location and/or time data; the volume of data that the user device 240 transmits or receives at the various locations and/or times is estimated based on, for example, demographics or other information known about the user. Moreover, for example, in some embodiments the location and/or time data, volume of data, and or other network usage data associated with user device 240 is determined, estimated, or recorded by an apparatus other than user device 240. For example, the access points to which user device 240 connects may transmit, directly or indirectly, network usage data to server 230. Moreover, for example, server 230 may determine, estimate, or record, network usage regarding user device 240.

As described in more detail below, server 230 may be configured to determine an impact of the network device usage of the user device 240 on the network performance status of the first network 210 and to determine an impact of the network device usage of the user device 240 on the network performance status of the second network 220. For example, server 230 may determine whether and how significant it would be for the user device 240 to change the network it is using from the first network 210 to the second network 220 based on historic usage information associated with the user device 240 that may be stored in the user device itself or at a remote location. Based on the determination, server 230 may output data associated with a change of network being used for the user device 240. For example, server 230 may output an offer to the user device 240 to switch the network it is using (which may include, for example, an offer to change a CSP subscription), may output data that causes user device 240 to switch the network it is using (which may include, for example, a change of CSP subscription), may output data to the first network 210 and/or the second network 220 to allow both CSPs to bid on the user's usage (e.g., to determine which CSP is willing to offer usage for the lowest cost or highest performance, or to determine which CSP is willing to offer a third party the largest fee to reveal the identity of the user controlling user device 240), or may output the determined impact data to a device in the first network 210 and/or a device in the second network 220 in exchange for a predetermined fee or as part of an agreement.

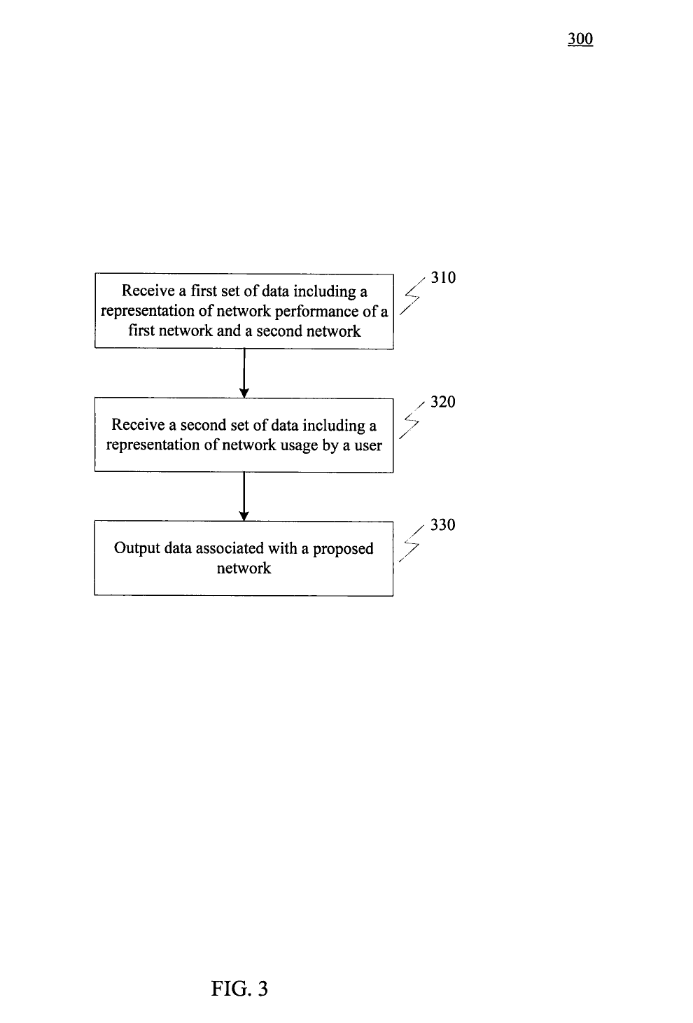

FIG. 3 depicts an example network selection method 300 for implementing some of the disclosed embodiments. In some embodiments method 300 may be implemented as one or more computer programs executed by a processor. Moreover, in some embodiments, method 300 may be implemented by a server (e.g., a server having one or more processors executing one or more computer programs stored on a non-transitory computer readable medium).

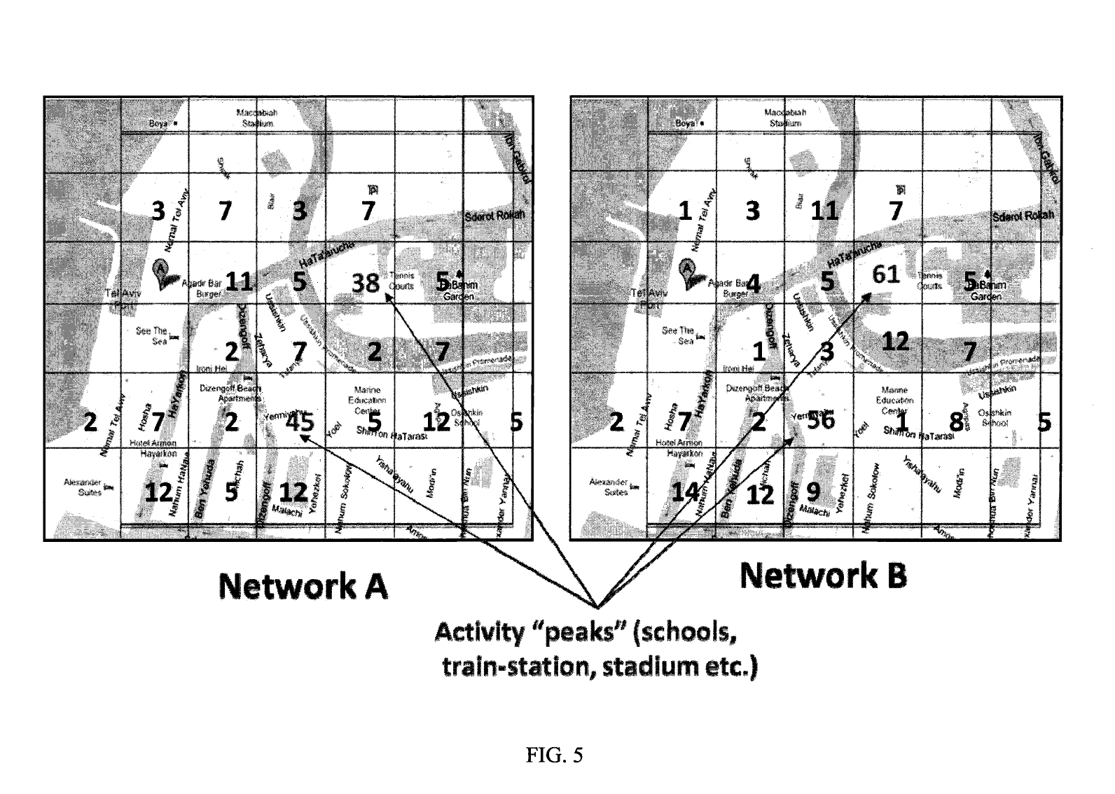

Method 300 begins by receiving a set of data reflecting network performance status of a first network at a plurality of locations and/or times and network performance status of a second network at the plurality of locations and/or times (step 310). The set of data may include data received from a single source or data received from a plurality of sources. In some embodiments, the plurality of locations are pre-defined geographical areas in which the first network and the second network have overlapping service. For example, FIG. 5 depicts a geographical region in which two CSPs may have overlapping service. As depicted in FIG. 5, the geographical region may be divided into pre-defined regions (e.g., squares of a size between 10×10 meters and 100×100 meters). In some embodiments, the plurality of locations are limited to geographic areas in which a device associated with the user has transmitted or received data using a wireless network. In some embodiments, the plurality of locations are limited to geographic areas in which a device associated with the user has transmitted or received data using a wireless network within geographic region 100.

In some embodiments, data associated with one or more data sessions of one or more subscriber devices of the first network and the second network is reported to, for example, server 230. For example, one or more subscriber devices may report, among other things, data session characteristics (e.g., start and end time, data volume, and/or data speed) and/or locations of the subscriber devices. Alternatively, or additionally, one or more access points may report data session characteristics associated one or more subscriber devices (e.g., start and end time, data volume, bandwidth, and/or data speed) and/or locations of the access points or locations of the subscriber devices.

In some embodiments, a day is divided into one or more time sections. These sections may be equal or variable (e.g., a day may be divided into twelve equal 2-hour periods, or a day may be divided into a morning period (e.g., 5-9 a.m.), a work period (9-5 p.m.), and a night period (e.g., 5 p.m.-5 a.m.)). In some embodiments, based on the reported data, an aggregate of all data traffic volume within a location region and a time section is determined. Traffic volume may be representative of the actual total traffic volume, may be representative of the relative traffic volume as compared to the maximum traffic volume that a network can accommodate within a location region, or may be representative of some other characteristic of the traffic volume within the location region.

In some embodiments, additional or alternative characteristics of the network performance status are determined. For example, an average data speed, a data speed variance, and/or a data bandwidth, within a location region and a time section may be determined.

In some embodiments, the network performance status data is averaged over repeated time sections. For example, data regarding the same time section may be measured over multiple days; an average data volume, data speed, data speed variance, and/or data bandwidth may be determined using the data measured over multiple days.

In some embodiments, a traffic intensity map may be displayed that presents the network performance status data over a geographical map. The map may be displayed, for example, on a display connected to the first network 210, second network 220, server 230, or user device 240. FIG. 5 depicts one example of network performance status data regarding two networks presented over a geographical map. FIG. 5 includes numbers within the location regions indicative of network performance status data, such as traffic volume, within a given location region. A higher number may be indicative of a higher traffic volume or a greater proportion of available data bandwidth used; a lower number may be indicative of a lower traffic volume or a smaller proportion of available data bandwidth used. In some embodiments, the network performance status data may be depicted visually using other means such as different colors or opacities. For example, each place on the map may be color coded based on the value of its associated traffic volume. As depicted in FIG. 5, the same location regions may be associated with different traffic volume or different available bandwidth for different networks, both in regions that are activity peaks (e.g., schools, train stations, stadiums, etc.) and in regions that have relatively less activity. Thus, different networks may be able to accommodate a user device within a location region with varying ease, cost and/or ability.

Method 300 also includes receiving a set of data reflecting network device usage for a device operating in association with the plurality of locations and/or times (step 320). The second set of data may include data received from a single source or data received from a plurality of sources. For example, as discussed above, server 230 may receive from user device 240 data on network usage at a plurality of locations and/or times within geographic area 100. Server 230 may receive the data from user device 240 in a single batch (e.g., at the end of a time period for which the user's network usage is monitored), in a plurality of batches (e.g., at the end of a predetermined time section, such as every two hours), on a continuous basis, or in response to a request sent to the user device 240. In some embodiments, based on the reported data, an aggregate of all network usage data within a location region and a time section is determined. In some embodiments, user device 240 includes an application that monitors data usage of the user device 240 continuously throughout a day or multiple days. Alternatively, or additionally, access points to which user device 240 connects may transmit, directly or indirectly, network usage data to server 230.

In some embodiments, server 230 may also, or alternatively, receive network usage of a user device at a plurality of locations and/or times based on an estimation. For example, in some embodiments, the user device 240 only stores or captures location and time data; the other network usage data of the user device 240, such as the volume of data the user device 240 transmits or receives at the various locations and/or times, is estimated by the user device 240, the server 230, or by some other apparatus, such as an access point to which user device 240 connects. Therefore, the representation of the network device usage by the user device may include, for example, at least one of an actual traffic volume, an estimated traffic volume, an actual traffic speed, or an estimated traffic speed, of a device associated with the user at each of the plurality of locations and/or times.

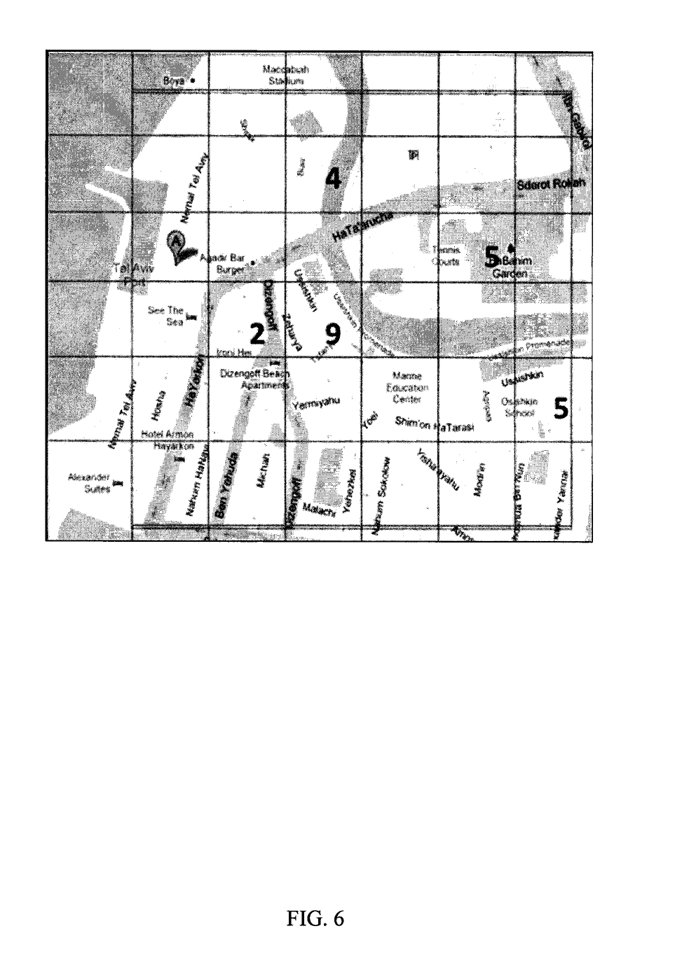

In some embodiments, a geographical map may be displayed that includes an indication of the network device usage of the device associated with the user such as, for example, at least one of the actual traffic volume, the estimated traffic volume, the actual traffic speed, or the estimated traffic speed, of the device associated with the user at each of the plurality of locations and/or times at which the device is used. The map may be displayed, for example, on a display connected to the first network 210, second network 220, server 230, or user device 240. For example, FIG. 6 depicts a geographical region, comprising the same plurality of location regions as shown in FIG. 5, in which an indication of the traffic volume of the user device throughout one day is displayed. In some embodiments, a data vector (e.g., a traffic volume vector associated with the user device) of the locations and/or times and corresponding traffic volumes (including, for example, actual traffic volumes or other values derived from actual traffic volumes) may be stored.

Method 300 also includes outputting data associated with a proposed network for the user device based, at least in part, on a determination of a first impact of the network device usage on the network performance status of the first network and a determination of a second impact of the network device usage on the network performance status of the second network (step 330). For example, in some embodiments, the data associated with a proposed network is determined based, at least in part, on a determination of whether the first impact or the second impact is a smaller impact.

The representation of the network device usage by the user may include a traffic volume, or a value derived from the traffic volume, of a device associated with the user at each of the plurality of locations and/or times. In some embodiments, the determination of the impact of the network device usage on the network performance status of the first network includes a comparison of the traffic volume of the user device at each of the plurality of locations and/or times to the representation of the network performance status of the first network at each of the plurality of locations and/or times (e.g., a comparison of the traffic volume vector associated with the user device to a traffic volume vector associated with the first network). Likewise, the determination of the impact of the network device usage on the network performance status of the second network may include a comparison of the traffic volume of the user device at each of the plurality of locations and/or times to the representation of the network performance status of the second network at each of the plurality of locations and/or times (e.g., a comparison of the traffic volume vector associated with the user device to a traffic volume vector associated with the second network).

In some embodiments, the impact of a user k on a network m during a time period t is determined using a Pearson formula:

$$Network\_impact \text{?} = \text{?} \frac{[ {S}_{i , k , t} - average ( S ) ] \cdot [ {N}_{i , m , t} , t - average ( {N}_{m} ) ]}{\sqrt{\text{?} {( {S}_{i , k , t} - \text{?} )}^{2}} \cdot \sqrt{\text{?} {( {N}_{i , m , t} - {\overline{N}}_{t} )}^{2}}}$$

$$\text{?} \text{indicates text missing or illegible when filed}$$

where i is the location region (e.g., one of the map squares depicted in FIGS. 5 and 6), S_{i,k,t} is the activity level (e.g., traffic volume) of user k at time period tin location region i, S̅ₜ is the average activity level of users during time period t, N_{i,m,t} is the activity level (e.g., traffic volume) of the network m at time period t in location region i, and N̅ₜ is the average activity level of networks during time period t. As discussed above, data regarding a user's activity in a plurality of location regions i may be present.

The total impact of a user device on a network may be determined based on the plurality of time periods for which data is present. That is, total network impact of a user k on a network m may be determined as follows:

$$Total\_Network {\_impact}_{k , m} = \text{?} {Network\_impact}_{t , k , m}$$

$$\text{?} \text{indicates text missing or illegible when filed}$$

The total network impact may be determined for the user for both the first network 210 and the second network 220. In some embodiments, the total network impact is determined for all networks that provide service to the geographic region in which the user device is active. In some embodiments, the data associated with the proposed network includes a determination of a particular network that is associated with the smallest total network impact determination.

In some embodiments, the data associated with the proposed network includes an offer to change the user device's network being used (which may include, for example, an offer to change a CSP subscription). For example, the user device may be using the first network 210. If the second network 220 is associated with a smaller total network impact determination than the first network 210, than the data associated with the proposed network may include an offer to change the network being used by user device's to the second network 220. Such an offer may include, for example, an output to the user device 240. For example, user device 240 may receive data that causes display of an option to switch network being used to the second network 220. Alternatively, for example, some other device may display an option to switch network being used to the second network 220. In some embodiments, changing networks being used may include dynamic switching between networks without requesting a user's agreement. For example, a check may be performed periodically to determine a “best network” (e.g., a network that the user device would have a minimal impact on) and if the user device is subscribed to a network other than the best network, the user device may be sent a command to relocate to the best network.

In some embodiments, the data associated with the proposed network includes data that causes the user device to use the second network. For example, the user device may be using the first network. If the second network is associated with a smaller total network impact determination than the first network, than the data associated with the proposed network may include data that causes the user device to use to the second network (which may include, for example, a change in CSP subscription). This may include, for example, configuration data sent to the second network and/or the user device 240.

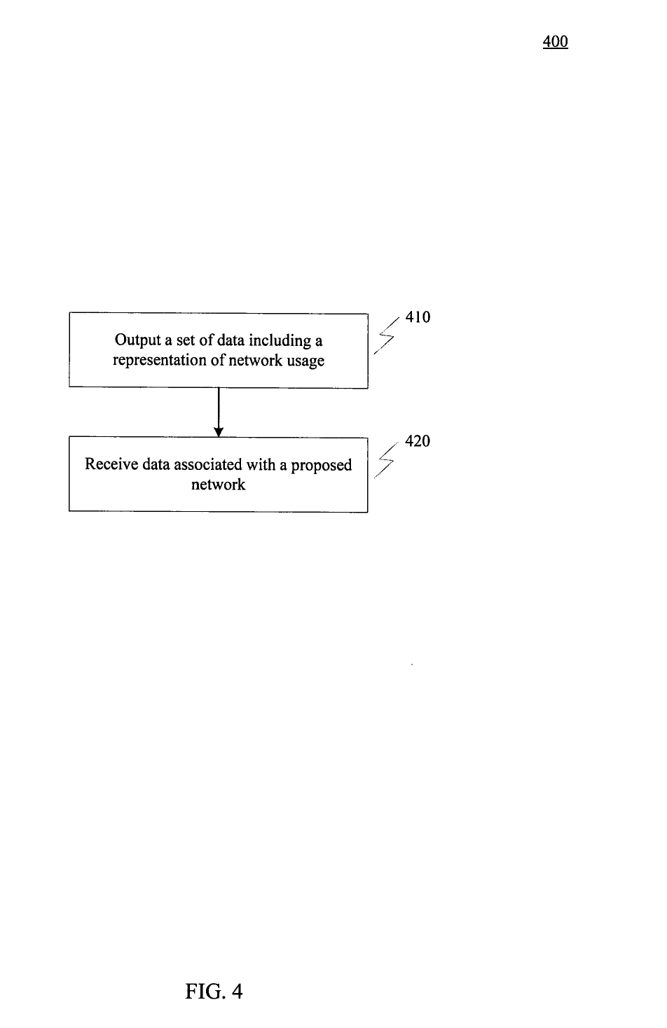

FIG. 4 depicts an example network selection method 400 for implementing some of the disclosed embodiments. In some embodiments method 400 may be implemented as one or more computer programs. Moreover, in some embodiments, method 300 may be implemented by a user device (e.g., a user device having one or more processors executing one or more computer programs stored on a non-transitory computer readable medium).

Method 400 begins with outputting a set of data reflecting network device usage for a device operating in association with a plurality of locations and/or times (step 410). For example, user device 240 may output to server 230 a set of data including a representation of network usage of the user device 240 at a plurality of locations and/or times. For example, user device 240 may transmit data to server 230 in a single batch (e.g., at the end of a time period for which the user device's network usage is monitored), in a plurality of batches (e.g., at the end of a predetermined time section, such as every two hours), on a continuous basis, or in response to a request sent from the server 230. In some embodiments, based on the reported data, an aggregate of all network usage data within a location region and a time section is determined. In some embodiments, user device 240 includes an application that monitors data usage of the user device 240 continuously throughout a day or multiple days.

As discussed above, the representation of the network device usage may include, for example, at least one of an actual traffic volume, an estimated traffic volume, an actual traffic speed, or an estimated traffic speed, of a device 240 associated with a user at each of a plurality of locations and/or times. In some embodiments, the plurality of locations are geographical areas in which the user device 240 has transmitted or received data using a wireless network.

In some embodiments, a geographical map is displayed by the user device 240 that includes an indication of the network device usage of the device 240 such as, for example, at least one of the actual traffic volume, the estimated traffic volume, the actual traffic speed, or the estimated traffic speed, of the device associated with the user at each of the plurality of locations and/or times at which the device is used.

Method 400 also includes receiving data associated with a proposed network for the user device based, at least in part, on a determination of a first impact of the network device usage on network performance status of a first network and a determination of a second impact of the network device usage on network performance status of a second network (step 420). The impact determination may be made, for example, by the server 230 in the same or substantially the same manner described above with respect to method 300. The received data associated with the proposed network may include, for example, an offer to change the network a user device is using (e.g., the user device 240 may display an option to switch networks to the user) or data that causes the user's usage to change to the second network (e.g., configuration data that configures the user device 240 and/or a network, such as the first network 210 or second network 220, to connect the user device to the network). In some embodiments, the data associated with the proposed network is received in response to a request from the user device 240 to the server 230. In other embodiments, the data associated with the proposed network is received from server 230 without a request from the user device 240. For example, the data associated with the proposed network may be received once the server 230 has acquired enough data to determine an impact of the network device usage on network performance status of a first network and determine an impact of the network device usage on network performance status of a second network.

By implementing the disclosed embodiments, both users and CSPs can make more efficient and informed decisions regarding selection of networks being used. For example, by knowing how a user's network usage will affect a network, the CSP can determine whether networks it offers access to can handle the network device usage without affecting, or without significantly affecting, the experience of other users, whether it can afford to install additional access points to handle the network device usage, and/or whether it can offer a usage price lower than a competitor CSP while maintaining a profit. Similarly, a user may be able to make an informed decision regarding whether a cheaper CSP subscription will provide a satisfactory experience (e.g., sufficient data speeds, bandwidth, and/or data volume availability).

Embodiments and all of the functional operations described in this specification can be implemented in digital electronic circuitry, or in computer software, firmware, or hardware, including the structures disclosed in this specification and their structural equivalents, or in combinations of them. Embodiments can be implemented as one or more computer program products, i.e., one or more modules of computer program instructions encoded on a computer readable medium, e.g., a machine readable storage device, a machine readable storage medium, a memory device, or a machine readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, which is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification (e.g., FIGS. 3-4) can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client/server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments have been described. Other embodiments are within the scope of the following claims.

What is claimed is:

1. A network selection method, comprising:
receiving, by a processor, a first set of data reflecting network performance status of a first network at a plurality of locations and network performance status of a second network at the plurality of locations;
receiving, by the processor, a second set of data reflecting network device usage for a device operating in association with the plurality of locations; and
outputting, by the processor, data associated with a proposed network for the device based, at least in part, on a determination of a first impact of the network device usage on the network performance status of the first network and a determination of a second impact of the network device usage on the network performance status of the second network.

2. The network selection method of claim 1, wherein the plurality of locations are geographical areas in which the device has transmitted or received data using a wireless network.

3. The network selection method of claim 1, wherein the first set of data is associated with:
at least one of a traffic volume or traffic speed of the first network at each of the plurality of locations, and
at least one of a traffic volume or traffic speed of the second network at each of the plurality of locations.

4. The network selection method of claim 3, further comprising:
displaying a traffic intensity map associated with at least one of the first network or the second network.

5. The network selection method of claim 3,
wherein the at least one of a traffic volume or traffic speed of the first network at each of the plurality of locations is determined based on an aggregation of traffic produced by a set of users of the first network in a respective location, and
wherein the at least one of a traffic volume or traffic speed of the second network at each of the plurality of locations is determined based on an aggregation of traffic produced by a set of users of the second network in a respective location.

6. The network selection method of claim 1, wherein the first set of data further reflects the network performance status of the first network at a plurality of times and the network performance status of the second network at the plurality of times.

7. The network selection method of claim 1, wherein the second set of data is associated with at least one of an actual traffic volume, an estimated traffic volume, an actual traffic speed, or an estimated traffic speed, of the device at each of the plurality of locations.

8. The network selection method of claim 7, further comprising:
displaying a geographical map that is associated with an indication of the at least one of the actual traffic volume, the estimated traffic volume, the actual traffic speed, or the estimated traffic speed, of the device at each of the plurality of locations.

9. The network selection method of claim 1, wherein the second set of data is associated with a traffic volume of the device at each of the plurality of locations, and further wherein the determination of the first impact of the network device usage on the network performance status of the first network is associated with a comparison of the traffic volume of the device at each of the plurality of locations to the network performance status of the first network at each of the plurality of locations.

10. The network selection method of claim 9, wherein the network performance status of the first network is associated with a traffic volume for each of the plurality of locations at a time when the device is active at a respective location.

11. The network selection method of claim 1,
wherein the determination of the first impact of the network device usage on the network performance status of the first network is associated with a determination of a Pearson correlation between a traffic volume vector associated with the device and a traffic volume vector associated with the first network, and
wherein the determination of the second impact of the network device usage on the network performance status of the second network is associated with a determination of a Pearson correlation between a traffic volume vector associated with the device and a traffic volume vector associated with the second network.

12. The network selection method of claim 11, wherein the device is using the first network, and wherein the data associated with the proposed network is based on a determination that the Pearson correlation between the traffic volume vector associated with the device and the traffic volume vector associated with the second network is lower than the Pearson correlation between the traffic volume vector associated with the device and the traffic volume vector associated with the first network.

13. The network selection method of claim 1, wherein the device is using the first network, and wherein the data associated with the proposed network is associated with an offer to change the device's usage to the second network.

14. The network selection method of claim 1, wherein the device is using the first network, and wherein the data associated with the proposed network is associated with data that causes the device's usage to change to the second network.

15. The network selection method of claim 1, wherein the first set of data is associated with data received from a set of users of the first network and data received from a set of users of the second network.

16. The network selection method of claim 1, wherein the data associated with the proposed network is further determined based, at least in part, on a determination of whether the first impact or the second impact is a smaller impact.

17. The network selection method of claim 1, wherein the first network is associated with a plurality of small cell access points or WLAN access points and the second network is associated with a plurality of small cell access points or WLAN access points.

18. The network selection method of claim 1, wherein the first network is associated with a plurality of cellular access points and the second network is associated with a plurality of small cell access points or WLAN access points.

19. A network selection method, comprising:
outputting, by a processor, a set of data reflecting network device usage for a device operating in association with a plurality of locations; and
receiving, by the processor, data associated with a proposed network for the device based, at least in part, on a determination of a first impact of the network device usage on network performance status of a first network and a determination of a second impact of the network device usage on network performance status of a second network.

20. The network selection method of claim 19, wherein the plurality of locations are geographical areas in which the device has transmitted or received data using a wireless network.

21. The network selection method of claim 19, further comprising:
displaying a traffic intensity map associated with at least one of the first network or the second network.

22. The network selection method of claim 19, wherein the set of data is associated with at least one of an actual traffic volume, an estimated traffic volume, an actual traffic speed, or an estimated traffic speed, of the device at each of the plurality of locations.

23. The network selection method of claim 19, further comprising:
displaying a geographical map that is associated with an indication of the at least one of the actual traffic volume, the estimated traffic volume, the actual traffic speed, or the estimated traffic speed, of the device at each of the plurality of locations.

24. The network selection method of claim 19,
wherein the determination of the first impact of the network device usage on the network performance status of the first network is associated with a determination of a Pearson correlation between a traffic volume vector associated with the device and a traffic volume vector associated with the first network, and
wherein the determination of the second impact of the network device usage on the network performance status of the second network is associated with a determination of a Pearson correlation between a traffic volume vector associated with the device and a traffic volume vector associated with the second network.

25. The network selection method of claim 24, wherein the device is using the first network, and wherein the data associated with the proposed network is based on a determination that the Pearson correlation between the traffic volume vector associated with the device and the traffic volume vector associated with the second network is lower than the Pearson correlation between the traffic volume vector associated with the device and the traffic volume vector associated with the first network.

26. The network selection method of claim 19, wherein the device is using the first network, and wherein the data associated with the proposed network is associated with an offer to change the device's usage to the second network.

27. The network selection method of claim 19, wherein the device is using the first network, and wherein the data associated with the proposed network is associated with data that causes the device's usage to change to the second network.

28. A server, comprising:
at least one processor; and
at least one memory device including instructions that, when executed by the at least one processor, configure the at least one processor to:
receive a first set of data reflecting network performance status of a first network at a plurality of locations and network performance status of a second network at the plurality of locations;
receive a second set of data reflecting network device usage for a device operating in association with the plurality of locations; and
output data associated with a proposed network for the device based, at least in part, on a determination of a first impact of the network device usage on the network performance status of the first network and a determination of a second impact of the network device usage on the network performance status of the second network.

29. The server of claim 28, wherein the plurality of locations are geographical areas in which the device has transmitted or received data using a wireless network.

30. The server of claim 28, wherein the first set of data is associated with:
at least one of a traffic volume or traffic speed of the first network at each of the plurality of locations, and
at least one of a traffic volume or traffic speed of the second network at each of the plurality of locations.

31. The server of claim 30, wherein the instructions, when executed by the at least one processor, further configure the at least one processor to:
output, to a display, a traffic intensity map associated with at least one of the first network or the second network.

32. The server of claim 30,
wherein the at least one of a traffic volume or traffic speed of the first network at each of the plurality of locations is determined based on an aggregation of traffic produced by a set of subscribers to the first network in a respective location, and
wherein the at least one of a traffic volume or traffic speed of the second network at each of the plurality of locations is determined based on an aggregation of traffic produced by a set of subscribers to the second network in a respective location.

33. The server of claim 28, wherein the first set of data further reflects the network performance status of the first network at a plurality of times and the network performance status of the second network at the plurality of times.

34. The server of claim 28, wherein the second set of data is associated with at least one of an actual traffic volume, an estimated traffic volume, an actual traffic speed, or an estimated traffic speed, of the device at each of the plurality of locations.

35. The server of claim 34, wherein the instructions, when executed by the at least one processor, further configure the at least one processor to:
output, to a display, a geographical map that is associated with an indication of the at least one of the actual traffic volume, the estimated traffic volume, the actual traffic speed, or the estimated traffic speed, of the device at each of the plurality of locations.

36. The server of claim 28, wherein the second set of data is associated with a traffic volume of the device at each of the plurality of locations, and further wherein the determination of the first impact of the network device usage on the network performance status of the first network is associated with a comparison of the traffic volume of the device at each of the plurality of locations to the network performance status of the first network at each of the plurality of locations.

37. The server of claim 36, wherein the network performance status of the first network is associated with a traffic volume for each of the plurality of locations at a time when the device is active at a respective location.

38. The server of claim 28,
wherein the determination of the first impact of the network device usage on the network performance status of the first network is associated with a determination of a Pearson correlation between a traffic volume vector associated with the device and a traffic volume vector associated with the first network, and
wherein the determination of the second impact of the network device usage on the network performance status of the second network is associated with a determination of a Pearson correlation between a traffic volume vector associated with the device and a traffic volume vector associated with the second network.

39. The server of claim 38, wherein the device is subscribed to the first network, and wherein the data associated with the proposed network is based on a determination that the Pearson correlation between the traffic volume vector associated with the device and the traffic volume vector associated with the second network is lower than the Pearson correlation between the traffic volume vector associated with the device and the traffic volume vector associated with the first network.

40. The server of claim 28, wherein the device is using the first network, and wherein the data associated with the proposed network is associated with an offer to change the device's usage to the second network.

41. The server of claim 28, wherein the device is using the first network, and wherein the data associated with the proposed network is associated with data that causes the device's usage to change to the second network.

42. The server of claim 28, wherein the first set of data is associated with data received from a set of users of the first network and data received from a set of users of the second network.

43. The server of claim 28, wherein the data associated with the proposed network is further determined based, at least in part, on a determination of whether the first impact or the second impact is a smaller impact.

44. A mobile device, comprising:
at least one processor; and
at least one memory device including instructions that, when executed by the at least one processor, configure the at least one processor to:
output a set of data reflecting network device usage for a device operating in association with a plurality of locations; and
receive data associated with a proposed network for the device based, at least in part, on a determination of a first impact of the network device usage on network performance status of a first network and a determination of a second impact of the network device usage on network performance status of a second network.

45. The mobile device of claim 44, wherein the plurality of locations are geographical areas in which the device has transmitted or received data using a wireless network.

46. The mobile device of claim 44, wherein the instructions, when executed by the at least one processor, further configure the at least one processor to:
output, to a display, a traffic intensity map associated with at least one of the first network or the second network.

47. The mobile device of claim 44, wherein the set of data is associated with at least one of an actual traffic volume, an estimated traffic volume, an actual traffic speed, or an estimated traffic speed, of the device at each of the plurality of locations.

48. The mobile device of claim 44, wherein the instructions, when executed by the at least one processor, further configure the at least one processor to:
output, to a display, a geographical map that is associated with an indication of the at least one of the actual traffic volume, the estimated traffic volume, the actual traffic speed, or the estimated traffic speed, of the device at each of the plurality of locations.

49. The mobile device of claim 44,
wherein the determination of the first impact of the network device usage on the network performance status of the first network is associated with a determination of a Pearson correlation between a traffic volume vector associated with the device and a traffic volume vector associated with the first network, and
wherein the determination of the second impact of the network device usage on the network performance status of the second network is associated with a determination of a Pearson correlation between a traffic volume vector associated with the device and a traffic volume vector associated with the second network.

50. The mobile device of claim 49, wherein the device is using the first network, and wherein the data associated with the proposed network is based on a determination that the Pearson correlation between the traffic volume vector associated with the device and the traffic volume vector associated with the second network is lower than the Pearson correlation between the traffic volume vector associated with the device and the traffic volume vector associated with the first network.

51. The mobile device of claim 44, wherein the device is using the first network, and wherein the data associated with the proposed network is associated with an offer to change the device's usage to the second network.

52. The mobile device of claim 44, wherein the device is using the first network, and wherein the data associated with the proposed network is associated with data that causes the device's usage to change to the second network.
